(19) United States
(12) Patent Application Publication
(10) Pub. No.: US 2025/0076040 A1
(43) Pub. Date: Mar. 6, 2025

(54) SENSOR

(71) Applicant: Airbus Operations Limited, FILTON (GB)

(72) Inventors: Ian SANDALL, FILTON (GB); Adam HUGHES, FILTON (GB)

(21) Appl. No.: 18/816,184

(22) Filed: Aug. 27, 2024

(30) Foreign Application Priority Data
Aug. 30, 2023 (GB) 2313203.8

(51) Int. Cl. G01C 5/00; B64C 13/16

(52) U.S. Cl. CPC G01C 5/005; B64C 13/16

(57) ABSTRACT

A ground detection system for an aircraft based on capacitive sensing. The system comprises an electrode mounted to an aircraft landing gear. As the aircraft landing gear approaches the ground, the electrode and the ground together form a variable capacitor having a capacitance that depends on a distance of the electrode from the ground. Signal processing electronics are used to measure the capacitance and, on the basis of the measured capacitance, determine a distance of the aircraft from the ground.

### CROSS-REFERENCES TO RELATED APPLICATIONS

This application claims the benefit of the United Kingdom Patent Application No. 2313203.8 filed on Aug. 30, 2023, the entire disclosures of which are incorporated herein by way of reference.

### FIELD OF THE INVENTION

The present disclosure relates to ground detection systems for aircraft. More particularly, but not exclusively, this invention concerns a ground detection system for an aircraft based on capacitive sensing.

### BACKGROUND OF THE INVENTION

An aircraft landing gear typically comprises at least two sets of wheels mounted on two respective landing gear struts. The landing gear struts are normally located symmetrically about a longitudinal axis of the aircraft (i.e., at the same distance along a length of the aircraft). When landing the aircraft it is important to ensure that both sets of wheels are in contact with the ground before applying braking, as braking while only one set of wheels is on the ground can destabilize the aircraft due to the off-center force applied by only one set of brakes. Equally, it is important that the pilots take action to slow the aircraft as soon as possible once it has landed to permit the aircraft to land at a wider variety of airports (for example, including those with shorter runways). It is therefore important that a pilot of an aircraft can accurately and readily determine when the wheels of the aircraft make contact with the ground.

To that end, aircraft often employ ground contact detection systems which operate to detect and alert a pilot to the wheels of an aircraft making contact with the ground. Typically, such systems operate by detecting compression of landing gear suspension in excess of a predetermined threshold.

As aircraft designs become lighter, it is likely that aircraft will need to be in contact with the ground for longer before the compression of the suspension is sufficient to exceed the predetermined threshold and trigger the ground contact detection system. This would result in delayed ground contact detection, and therefore also delayed aircraft braking. It is possible to remedy this shortcoming by providing softer suspension, such that the suspension compresses more quickly after landing. However, to do so risks compromising the shock-absorbing performance of the suspension.

The present invention seeks to mitigate one or more of the above-mentioned problems. Alternatively or additionally, the present invention seeks to provide an improved ground detection system for an aircraft.

### SUMMARY OF THE INVENTION

The present invention provides, according to a first aspect, a ground detection system for an aircraft. The system comprises an aircraft landing gear, an electrode mounted to the aircraft landing gear, and signal processing electronics. The electrode is arranged such that, as the aircraft landing gear approaches the ground, the electrode and the ground together form a variable capacitor having a capacitance that depends on a distance of the electrode from the ground. The signal processing electronics are configured to measure the capacitance and, on the basis of the measured capacitance, determine a distance of the aircraft from the ground.

Embodiments of the present invention can provide a new ground detection system for detecting not only ground contact, but also the distance of the aircraft from the ground. Furthermore, because the system does not operate by detecting compression of a landing gear suspension, the design of that suspension can be optimized without the need for compromise to accommodate the ground detection system.

It may be that the system is configured to detect proximity of the wheels to the ground, rather than merely contact of the wheels with the ground. Thus, the determined distance may comprise more than a mere binary indication that the wheels are in contact with the ground. The determined distance may provide a numerical indication of a distance between a lowest point of the wheels and the ground.

The signal processing electronics may comprise an oscillator having a resonant tank circuit. In such cases, it may be that the variable capacitor formed by the electrode and the ground comprises part of the resonant tank circuit. It may therefore be that variation in the capacitance of the variable capacitor causes a corresponding variation in an operating frequency of the oscillator. The signal processing electronics may be configured to measure the capacitance by measuring the operating frequency of the oscillator. The oscillator may, for example, comprise a Colpitts oscillator, a Hartley oscillator, or a Clapp oscillator. It will be appreciated by the skilled person that other types of oscillator may also be used.

By incorporating the variable capacitor into a resonant tank circuit for an oscillator, the variation in distance from the ground is converted into a corresponding variation in the frequency of the oscillator. Determining the distance by measuring the frequency of the oscillator can provide improved rejection of electrical noise.

The aircraft landing gear may comprise a wheel. In such cases, it may be that the wheel forms the electrode. As the wheel is circular (so has an infinite order of rotational symmetry), the distance between the wheel and the ground does not vary in dependence on the rotation of the wheel (for example, as the wheel turns). Thus, the wheel can be treated as static electrode for the purposes of capacitive ground detection. It may be that the signal processing electronics are mounted on the wheel. Thus, it may be that the signal processing electronics are mounted such that they rotate with the wheel as it turns.

Utilizing the wheel as the electrode can enable capacitive ground detection without the need for an additional electrode to be added to the landing gear. This reduces the weight of the ground detection system, which can improve aircraft efficiency. Furthermore, the wheel is typically the closest metallic part of the aircraft to the ground. The proximity of the electrode to the ground determines the magnitude of the variation in capacitance. Thus, utilizing the wheel as the electrode can provide increased measurement sensitivity.

It may be that the signal processing electronics are configured to detect, on the basis of the determined distance falling below a predetermined distance threshold, that one or more aircraft wheels (for example, all aircraft landing gear wheels on the associated landing gear strut) are in contact with the ground. Thus, the signal processing electronics may be configured to detect (for example, on the basis of the determined distance falling below the predetermined distance threshold), that the aircraft has landed.

It may be that the aircraft landing gear comprises multiple wheels. It may be that the aircraft landing gear comprises multiple landing gear struts (for example, each having one or more respective wheels). It may be that the system comprises an electrode for at least one wheel, optionally at least two wheels and/or optionally all wheels, of each of the landing gear struts of the aircraft. It may be that the system comprises an electrode for each landing gear wheel on the aircraft. The signal processing electronics may be configured to, for each of the electrodes, measure a capacitance of a variable capacitor formed by the electrode and the ground. Thus, the system may be configured to measure the capacitance of a plurality of variable capacitors. The signal processing electronics may be configured to determine (for example, based on the respective measured capacitance), for each of the variable capacitors, a distance of the respective wheel from the ground.

It may be that the signal processing electronics are configured to detect, for each individual landing gear wheel on the aircraft, that the wheel has made contact with the ground (for example, on the basis of a respective determined distance falling below a respective predetermined distance threshold). It may be that different landing gear wheels on the aircraft are associated with different predetermined distance thresholds (for example, where the size and/or structure of wheels and/or landing gear struts differ). Thus, it may be that the signal processing electronics are configured to monitor a plurality of capacitances (and thereby distances). In such cases, it may be that the signal processing electronics are configured to monitor the plurality of distances to determine that the aircraft has landed. It may be that the signal processing electronics are configured to determine that the aircraft has landed on the basis of one or more (for example, all) of the plurality of distances falling below a predetermined distance threshold (for example, respective predetermined distance thresholds).

As discussed above, it is important that a pilot of an aircraft can accurately and readily determine when the wheels of the aircraft make contact with the ground in order to ensure prompt action to slow the aircraft on landing. The signal processing electronics being configured to detect that the aircraft wheels have made contact with the ground can help to ensure reliable and accurate determination of when the aircraft has landed.

The signal processing electronics may be configured to determine the predetermined distance threshold by, when the aircraft is in a weight on wheels configuration, measuring the capacitance of the variable capacitor. It may be that determining the predetermined distance threshold comprises applying one or more scaling factors to the capacitance measured while the aircraft is in a weight on wheels configuration. The one or more scaling factors may be based on data characterizing environmental conditions. Thus, the signal processing electronics may be configured to receive data characterizing environmental conditions. The signal processing electronics may include one or more sensors configured to measure data indicative of one or more environment conditions and, on the basis of the measured data, determine one or more scaling factors to be applied to the measured capacitance to determine the predetermined distance threshold. Alternatively or additionally, the signal processing electronics may be configured to receive the data from one or more external sensors. The one or more environmental conditions may comprise one or more of: humidity, temperature, and weather conditions (for example, rain or mist). Where the signal processing electronics are configured to measure multiple capacitances and determine multiple distances (for example, in respect of multiple wheels), the process above may be repeated in respect of each of the multiple capacitances to determine respective predetermined distance thresholds (for example, in respect of each of the landing gear wheel sets or landing gear wheels). Thus, the signal processing electronics may be configured to determine the plurality of the predetermined distance thresholds (for example, by measuring the respective capacitances when the aircraft is in a weight on wheel configuration). Where the signal processing electronics are configured to measure multiple capacitances and determine multiple distances in respect of multiple wheels, at least some of the one or more scaling factors applied in respect of wheels yet to have made contact with the ground may be based on a scaling factor applied to a wheel that has already made contact with the ground.

Determining the predetermined distance threshold by measuring the capacitance of the variable capacitor when the aircraft is in a weight on wheels configuration can allow the signal processing electronics to perform automatic self-calibration (for example, to account for variations in environmental conditions).

It may be that the signal processing electronics are configured to generate, in response to detecting that the aircraft has landed, a signal indicative of the aircraft having landed. The signal may be transmitted to one or more systems for retarding the movement of the aircraft (for example, a braking control system or a spoiler control system). The signal may be transmitted to one or more avionics systems of the aircraft, for example in the cockpit (for example, for use by a pilot). It may (for example, where the electrode is formed by a wheel) be that the signal is transmitted wirelessly. Thus, the signal processing electronics may comprise an antenna and an associated transmitter.

The signal processing electronics may be configured to, in response to detecting that the aircraft has landed, cause the activation of one or more systems for retarding the movement of the aircraft (i.e., one or more aircraft deceleration systems). Activating one or more such systems may comprise one or more of: automatically reducing engine throttle, applying brakes, deploying one or more spoilers and/or air-brakes, and reversing the direction of engine thrust.

Automatically activating one or more systems to retard the movement of the aircraft in response to detecting that the aircraft has landed can ensure that the aircraft is slowed promptly, providing improved safety. Furthermore, activating such systems automatically can reduce the mental burden placed on the pilot(s) of the aircraft.

The signal processing electronics may be configured to, in response to detecting that the aircraft has landed, cause the generation of an alert (for example, for a pilot of the aircraft). The alert may comprise one or both of: a visual alert (for example, generating a message on a display in the cockpit) and an audible alert (for example, generated by a loudspeaker in the cockpit).

Generating an alert in response to detecting that the aircraft has landed can aid a pilot in reliably and accurately determining when the aircraft wheels have made contact with the ground, enabling a pilot to activate systems to slow the aircraft at an earlier time.

The signal processing electronics may be configured to repeat the measuring of the capacitance and the determining of a distance of the aircraft from the ground over a period of time to collect a series of measurements of the distance of the aircraft from the ground. The signal processing electronics may be configured to repeat the measuring of the capacitance and the determining of the distance at least once a second, at least twice a second, at least five times a second, or at least 10 times a second.

Repeating the measuring of the capacitance and the determining of the distance of the aircraft from the ground can allow the signal processing electronics to monitor the position of the aircraft in relation to the ground over a period of time (for example, a period of time during which the aircraft is landing).

The signal processing electronics may be configured to, on the basis of the series of measurements, determine a sink rate of the aircraft. It will be appreciated by the skilled person that the “sink rate” refers to a rate of descent of the aircraft towards the ground during landing. It may be that determining the sink rate comprises determining a rate of change in the measured distance. It may be that determining the sink rate comprises determining a difference between two of the measurements in the series.

Determining a sink rate of the aircraft can enable the ground detection system to evaluate the severity of a landing. The determined sink rate may be indicative of the forces to which the aircraft was subjected during the landing.

The signal processing electronics may be configured to detect that the aircraft has made a heavy landing by detecting that the determined sink rate exceeds a predetermined sink rate threshold. It may be that detecting that the aircraft has made a heavy landing comprises detecting that the determined sink rate exceeds the predetermined sink rate threshold at the time at which the aircraft makes contact with the ground (for example, as indicated by the predetermined distance threshold). It may be that the signal processing electronics are configured to maintain (for example, by storing data in a memory) a record of heavy landings (for example, including their date, time, and severity). A heavy landing can be defined as a landing which subjects the aircraft to forces in excess of specified thresholds (for example, forces exceeding those for which one or more aircraft structures are certified).

Detecting that the determined sink rate exceeds a predetermined sink rate threshold can allow the ground detection system to identify heavy landings. The ground detection system can then record the number or frequency of such landings (for example, for transmission to a monitoring system). This data could then be used to inform monitoring and preventative maintenance of one or more parts of the aircraft.

It may be that the determining of a sink rate (or a rate of change of capacitance) assists the ground detection system in determining whether or not a wheel has made contact with the ground.

The signal processing electronics may be configured to measure the capacitance and determine the distance of the aircraft from the ground while the aircraft is in flight. It may be that the signal processing electronics are configured to generate (for example, while in flight) a signal indicative of the distance of the aircraft from the ground.

Measuring the capacitance and determining the distance of the aircraft from the ground while the aircraft is in flight allows the ground detection system to be used to monitor the aircraft's approach to the ground, rather than merely detecting contact with the ground.

According to a second aspect of the invention there is also provided an aircraft comprising a ground detection system according to the first aspect.

The aircraft is preferably a passenger aircraft. The passenger aircraft preferably comprises a passenger cabin comprising a plurality of rows and columns of seat units for accommodating a multiplicity of passengers. The aircraft may have a capacity of at least 20 passengers, at least 50 passengers, or more than 50 passengers. The aircraft may be a commercial aircraft, for example a commercial passenger aircraft, for example a single aisle or twin aisle aircraft. The aircraft need not be configured for carrying passengers, but could, for example, be an aircraft of an equivalent size configured for cargo and/or used on a non-commercial basis. The aircraft may have a maximum take-off weight (MTOW) of at least 20 tons, optionally at least 40 tons, and possibly 50 tons or more. The aircraft may have an operating empty weight of at least 20 tons, optionally at least 30 tons, and possibly about 40 tons or more.

According to a third aspect of the invention there is also provided a method of ground detection for an aircraft. The method comprises: providing, on an aircraft landing gear, an electrode arranged such that, as the aircraft landing gear approaches the ground, the electrode and the ground together form a variable capacitor having a capacitance that depends on a distance of the electrode from the ground; measuring the capacitance of the variable capacitor; and determining, on the basis of the measured capacitance, a distance of the aircraft from the ground. The step of determining a distance of the aircraft from the ground may include deeming whether or not a wheel is in contact with the ground. The step of determining a distance of the aircraft from the ground may include outputting electronically the distance so determined, for example with a preciseness at least as precise as to the nearest 10 meters, and preferably at least to the nearest meter.

According to a fourth aspect of the invention there is also provided a computer program comprising instructions which, when the program is executed by a computer, cause the computer to carry out a method of ground detection for an aircraft. The method comprises: measuring a capacitance of a variable capacitor formed by an electrode mounted on a landing gear of the aircraft and the ground, wherein a capacitance of the variable capacitor depends on a distance of the electrode from the ground; and determining, on the basis of the measured capacitance, a distance of the aircraft from the ground.

According to a fifth aspect of the invention there is also provided an apparatus for measuring the distance of an aircraft from the ground. The apparatus comprises an electrical conductor mounted on structure of the aircraft and a detection circuit. The detection circuit is configured to: monitor a capacitance arising from proximity of the electrical conductor to the ground, and determine from the capacitance a distance of the aircraft structure from the ground. It may be that an embodiment of the fifth aspect of the invention is provided as a kit of parts, being formed of a detection circuit. and an electrical conductor separate from the structure of the aircraft to which it would be mounted when in use. The kit may comprise one or more fixings for mounting the electrical conductor on the structure of the aircraft.

According to a sixth aspect of the invention there is also provided an aircraft ground detection system comprising an electrode assembly comprising an electrode and signal processing electronics. When the electrode assembly is fixed to an aircraft landing gear, the aircraft ground detection system so formed may be in accordance with the first aspect of the invention including any optional features described or claimed herein.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the present invention will now be described by way of example only with reference to the accompanying schematic drawings of which:

FIG. 1 shows a schematic view of an aircraft landing gear incorporating a ground detection system according to a first embodiment of the invention;

FIG. 2 shows a schematic view of the signal processing electronics of FIG. 1;

FIG. 3 shows a schematic view of an aircraft according to a second embodiment of the invention; and

FIG. 4 shows a flow diagram illustrating a method according to a third embodiment of the invention.

### DETAILED DESCRIPTION OF THE PREFERRED EMBODIMENTS

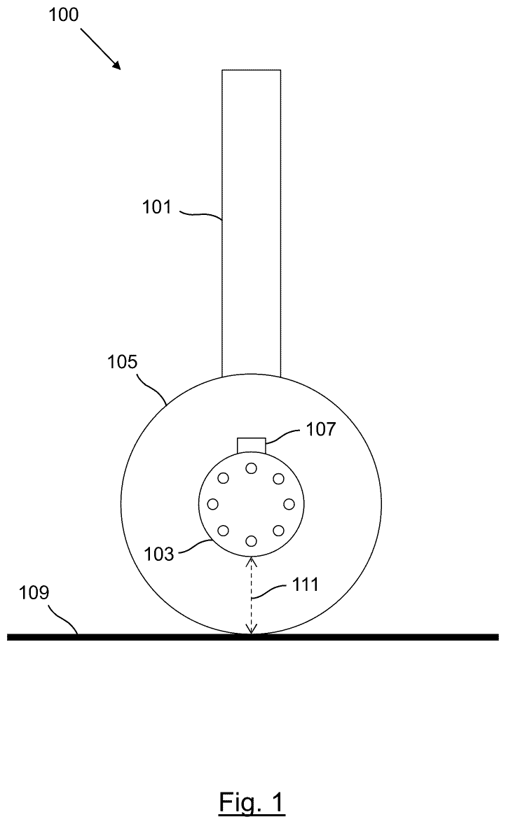

FIG. 1 shows a schematic view of an aircraft landing gear 100. The aircraft landing gear comprises a landing gear strut 101. A wheel 103 is mounted to the landing gear strut, such that the wheel 103 may rotate about its axis. It will be appreciated by the skilled person that the axis of the wheel 103 as shown in FIG. 1 extends into the page through the center of the wheel 103. A tire 105 is mounted on the wheel 103, such that the tire rotates with the wheel 103. The aircraft landing gear 100 further comprises signal processing electronics 107.

In this example embodiment, the signal processing electronics 107 are mounted on the wheel 103. Thus, the signal processing electronics 107 are configured to rotate with the wheel 103 as it turns. It will be appreciated by the skilled person that in other embodiments, it may be that the signal processing electronics 107 are not mounted on the wheel 103. The signal processing electronics 107 may, for example, be mounted (at least partly) on the landing gear strut 101. Similarly, although in this example embodiment the signal processing electronics 107 are formed as a single unit, in alternative embodiments the signal processing electronics 107 may be formed of multiple separate units. In such cases, one or more of the multiple units may be mounted on the wheel 103 and one or more other of the multiple units may be mounted elsewhere (for example, on the landing gear strut 101).

FIG. 1 shows the aircraft landing gear 100 as it would be when in use (i.e., when an aircraft to which it is attached is on the ground). The aircraft landing gear 100 (and thereby the aircraft) is supported on the ground 109 by the wheel 103, via the tire 105. Thus, the wheel 103 is separated from the ground 109 by a distance, illustrated by dashed arrow 111, determined by the tire 105.

The wheel 103 is formed of metal and so is electrically conductive. By contrast, the tire 105 and the gases contained within and surrounding the tire 105 are electrically insulating. Thus, the inventors of the present invention have recognized that the wheel 103 and the ground 109 can be treated as the electrodes of a capacitor, with the tire 105 and the gas it contains acting as a dielectric. Furthermore, the inventors have recognized that the capacitance of the capacitor formed by the wheel 103 and the ground 109 is dependent upon the distance of the wheel 103 from the ground 109. Thus, the wheel 103 and the ground 109 together form a variable capacitor, the capacitance of which depends on the distance of the wheel 103 from the ground 109.

Thus, the aircraft landing gear 100 can be said to comprise an electrode (in this example embodiment, the wheel 103) mounted to the aircraft landing gear 100 and arranged such that, as the aircraft landing gear 100 approaches the ground 109, the electrode 103 and the ground 109 together form a variable capacitor having a capacitance that depends on a distance 111 of the electrode 103 from the ground 109.

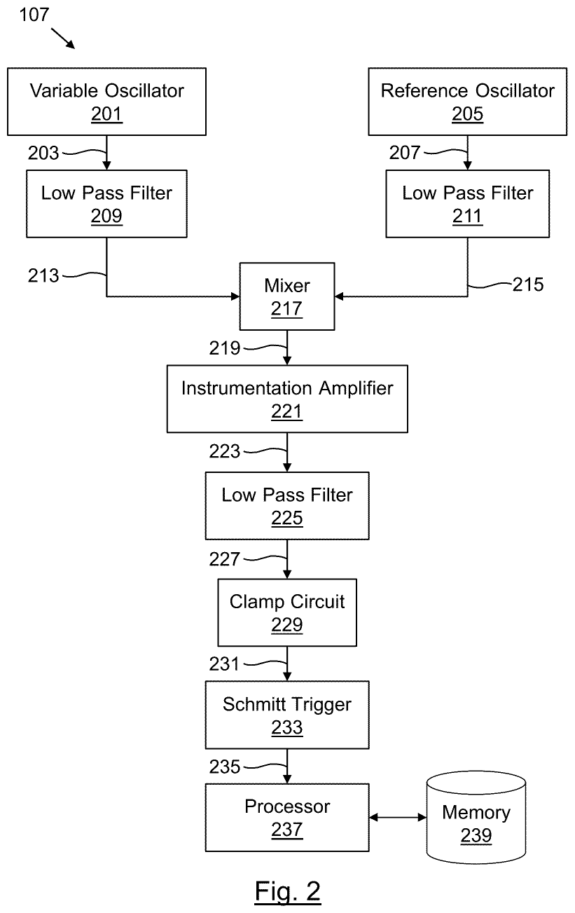

FIG. 2 shows a schematic view of the signal processing electronics 107 of FIG. 1.

The signal processing electronics 107 comprise a variable oscillator 201. In this example embodiment, the variable oscillator 201 comprises a resonant tank circuit (not shown). A reactance of the resonant tank circuit determines an operating frequency of the variable oscillator 201. The variable capacitor formed by the wheel 103 and the ground 109 comprises part of the resonant tank circuit, such that variation in the capacitance of the variable capacitor causes a corresponding variation in the reactance of the resonant tank circuit and thereby also in the operating frequency of the variable oscillator 201. Thus, variation in the distance between the wheel 103 and the ground 109 causes a corresponding variation in the operating frequency of the variable oscillator 201. In this example embodiment, the variable oscillator 201 comprises a Colpitts oscillator. However, it will be appreciated by the skilled person that, in other embodiments, other types of variable oscillator (for example, a Hartley oscillator or a Clapp oscillator) may alternatively be used. The variable oscillator 201 outputs a variable frequency sinusoidal wave 203.

The signal processing electronics 107 further comprise a reference oscillator 205. The reference oscillator is configured to generate a fixed reference frequency sinusoidal wave 207 for use in measuring the changing frequency of the variable frequency sinusoidal wave 203.

The signal processing electronics 107 further comprise a first low-pass filter 209 and a second low-pass filter 211. In this example embodiments, the low-pass filters 209, 211 comprise RC low-pass filters. However, it will be appreciated by the skilled person that other types of low-pass filter may alternatively be used. The low-pass filters 209, 211 operate to filter out high-frequency noise from the variable frequency sinusoidal wave 203 and the reference frequency sinusoidal wave 207 respectively to produce a filtered variable frequency sinusoidal wave 213 and a filtered reference frequency sinusoidal wave 215.

The signal processing electronics 107 further comprise a mixer circuit 217. The filtered variable frequency sinusoidal wave 213 and the filtered reference frequency sinusoidal wave 215 are input to the mixer circuit 217 to produce a mixer output signal 219 proportional to the product of two input signals (i.e., the product of the filtered variable frequency sinusoidal wave 213 and the filtered reference frequency sinusoidal wave 215). In this example embodiment, the mixer circuit 217 comprises a Gilbert cell mixer. However, it will be appreciated by the skilled person that, in other embodiments, other types of mixer circuit (for example, a ring diode mixer) may alternatively be used.

The signal processing electronics 107 further comprise an instrumentation amplifier 221. The mixer output signal 219 is input to the instrumentation amplifier 221, which operates to amplify the mixer output signal 219 and convert it from a differential signal to a single-ended signal. The instrumentation amplifier 221 outputs an amplified mixer output signal 223.

The signal processing electronics 107 further comprise an additional low-pass filter 225. The low-pass filter 225 operates on the amplified mixer output signal 223 to produce a filtered mixer output signal 227.

The signal processing electronics 107 further comprise a clamp circuit 229. The clamp circuit 229 operates to clamp negative excursions of the filtered mixer output signal 227 to 0V. Thus, the clamp circuit converts the sinusoidal input signal into a signal consisting of only the positive excursion of that sinusoid. The clamp circuit 229 thereby generates a clamped mixer output signal 231.

The signal processing electronics 107 further comprise a Schmitt trigger 233. The Schmitt trigger 233 operates on the clamped mixer output signal 231 to convert it from a clamped sinusoid (i.e., a signal consisting of only the positive excursion of a sinusoid) to a square wave having the same frequency as the clamped sinusoid. The Schmitt trigger 233 thereby generates a square wave signal 235.

The signal processing electronics 107 further comprise a processor 237 and an associated memory 239. The processor 237 is configured to operate on the basis of instructions stored in the associated memory 239. The processor 237 takes the square wave signal 235 as an input. The processor 237 is configured to utilize timer-based interrupts to calculate the period of the square wave signal 235 and, from the calculated period, determine the frequency of the square wave signal 235. The processor 237 is further configured to determine the capacitance of the variable capacitor formed by the wheel 103 and the ground 109 by measuring the operating frequency of the variable oscillator 201. It will be appreciated by the skilled person that the information embodied in the frequency of the variable oscillator 201 is preserved throughout the full extent of the signal processing chain between the variable oscillator 201 and the processor 237, such that the square wave signal 235 indicates the operating frequency of the variable oscillator 201. Thus, the processor 237 can determine the operating frequency of the variable oscillator 201 from the square wave signal 235. The skilled person will further appreciate that there is a fixed relationship (determined by the specific component level design of the variable oscillator 201 and its resonant tank circuit) between the operating frequency of the variable oscillator 201 and the capacitance of the variable capacitor formed by the wheel 103 and the ground 109. Thus, the processor 237 can, using pre-programmed knowledge of that design, determine from the operating frequency of the variable oscillator 201 the capacitance of that variable capacitor. The processor 237 is further configured to determine the distance of the wheel 103 from the ground based on the measured capacitance of the variable capacitor. In this example embodiment, the processor 237 is configured to determine the distance by reference to a look-up table (for example, stored in memory 239). The look-up table associates a plurality of capacitance values with corresponding distances of the wheel 103 from the ground 109. The processor 237 is configured to retrieve from the look-up table a distance associated with one or the plurality of stored capacitance values nearest to the measured capacitance. In other embodiments, the processor 237 may be configured to, where a measured capacitance is in between two stored capacitance values, interpolate between the two corresponding stored distance values.

Thus, the signal processing electronics 107 are configured to measure the capacitance of the variable capacitor formed by the wheel 103 and the ground 109 and, on the basis of the measured capacitance, determine a distance of the wheel 103 (and thereby of the aircraft) from the ground 109. Thus, the wheel 103 and the signal processing electronics 107 together form a ground detection system for an aircraft.

The processor 237 is further configured to detect, on the basis of the determined distance falling below a predetermined distance threshold, that the aircraft has landed. It will be appreciated by the skilled person that the height of the wheel 103 from the ground 109 is a function of the design of the aircraft, and therefore is known for a given aircraft. Thus, the processor 237 can determine when the aircraft has landed by comparing the measured distance to that known distance. The predetermined distance threshold is set at a level corresponding to just above that known distance, such that when the measured distance falls below the predetermined distance threshold, the processor 237 can determine that the aircraft has landed.

In this example embodiment, the processor 237 is further configured to determine the predetermined distance threshold. The processor 237 is configured to receive an indication that the aircraft is in a weight on wheels configuration and in response measure the capacitance of the variable capacitor. Thus, the processor 237 determines the capacitance associated with the weight on wheels configuration. The processor 237 then sets the pre-determined distance threshold based on that measured capacitance.

The processor 237 is further configured to, in response to detecting that the aircraft has landed, cause the activation of one or more aircraft deceleration systems. In this example embodiment, the processor 237 is configured to automatically apply the landing gear brakes. However, it will be appreciated by the skilled person that other embodiments of the present invention may operate other means for decelerating the aircraft (for example, by automatically deploying one or more spoilers/air brakes). It will be further appreciated by the skilled person that other embodiments of the present invention do not automatically activate one or more aircraft deceleration systems. In other such embodiments, the processor 237 is configured, alternatively or additionally, to generate an alert for a pilot of the aircraft.

The processor 237 is configured to repeat the measuring of the capacitance of the variable capacitor and the determining of a distance of the wheel 103 (and thereby the aircraft) from the ground 109 over a period of time. Thus, the processor 237 operates to collect a series of distance measurements characterizing the distance between the wheel 103 and the ground 109 over that period of time. The processor 237 is further configured to determine from the series of measurements a sink rate of the aircraft. In this example embodiment, the processor 237 is configured determine the sink rate by evaluating a rate of change in the distance of the wheel 103 from the ground 109.

The processor 237 is further configured to detect that the aircraft has made a heavy landing by detecting that the determined sink rate exceeds a predetermined sink rate threshold. In this example embodiment, the processor 237 detects a hard landing when the determined sink rate at the time of landing (as indicated by the determined distance falling below the predetermined distance threshold) exceeds the predetermined sink rate threshold.

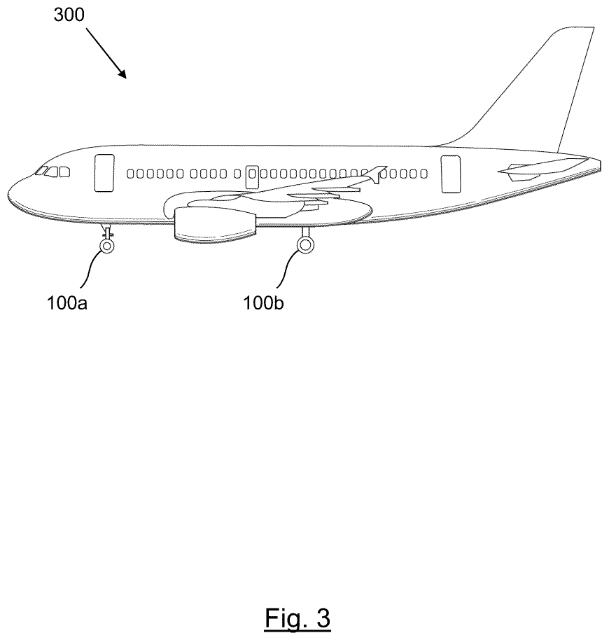

FIG. 3 shows a schematic view of an aircraft 300 according to a second embodiment of the invention. The aircraft comprises a first landing gear 100a and a second landing gear 100b. The first landing gear 100a and the second landing gear 100b each comprise a respective ground detection system as described above.

In this case, the wheel of the first landing gear 100a is of a different size to that of the second landing gear 100b. Thus, the ground detection system on the first landing gear 100a is configured differently to that on the second landing gear 100b, in order to account for those differing wheel sizes. For example, the memory of the ground detection system on the first landing gear 100a contains a different look-up table to that in the memory of the ground detection system on the second landing gear 100b. Similarly, the predetermined distance threshold of the ground detection system on the first landing gear 100a differs from that of the ground detection system on the second landing gear 100b.

In this example embodiment, each landing gear wheel on the aircraft 300 comprises a respective ground detection system. However, it will be appreciated by the skilled person that, in other embodiments, a single ground detection system may be configured to monitor multiple wheels (for example, all of the wheels mounted on a given landing gear strut).

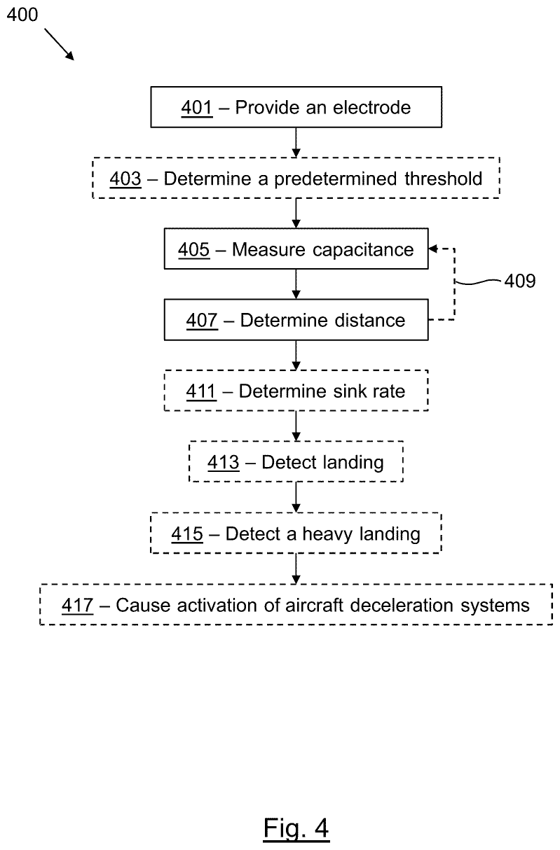

FIG. 4 shows a flow diagram illustrating a method 400 of ground detection for an aircraft according to a third embodiment of the invention.

A first step, illustrated by item 401, of the method 400 comprises providing, on an aircraft landing gear, an electrode arranged such that, as the aircraft landing gear approaches the ground, the electrode and the ground together form a variable capacitor having a capacitance that depends on a distance of the electrode from the ground. It may be that the aircraft landing gear comprises a wheel. It may be that the wheel forms the electrode. It may be that measuring the capacitance comprises measuring the operating frequency of an oscillator. It may be that the oscillator comprises a resonant tank circuit. It may be that the variable capacitor formed by the electrode and the ground comprises part of the resonant tank circuit, such that variation in the capacitance of the variable capacitor causes a variation in an operating frequency of the oscillator.

An optional second step, illustrated by item 403, of the method 400 comprises determining a predetermined distance threshold by, when the aircraft is in a weight on wheels configuration, measuring the capacitance of the variable capacitor.

A third step, illustrated by item 405, of the method 400 comprises measuring the capacitance of the variable capacitor. It may be that the measuring of the capacitance is performed while the aircraft is in flight.

A fourth step, illustrated by item 407, of the method 400 comprises determining, on the basis of the measured capacitance, a distance of the aircraft from the ground. It may be that the determining of the distance of the aircraft from the ground is performed while the aircraft is in flight.

The method may comprise repeating, represented by arrow 409, the measuring of the capacitance and the determining of a distance of the aircraft from the ground over a period of time to collect a series of measurements of the distance of the aircraft from the ground.

An optional fifth step, illustrated by item 411, of the method 400 comprises determining, on the basis of the series of measurements, a sink rate of the aircraft.

An optional sixth step, illustrated by item 413, of the method 400 comprises detecting (for example, on the basis of the determined distance falling below the predetermined distance threshold) that the aircraft has landed.

An optional seventh step, illustrated by item 415, of the method 400 comprises detecting that the aircraft has made a heavy landing (for example, by detecting that the determined sink rate exceeds a predetermined sink rate threshold).

An optional eighth step, illustrated by item 417, of the method 400 comprises causing, in response to detecting that the aircraft has landed, the activation of one or more aircraft deceleration systems.

While the present invention has been described and illustrated with reference to particular embodiments, it will be appreciated by those of ordinary skill in the art that the invention lends itself to many different variations not specifically illustrated herein. By way of example only, certain possible variations will now be described.

It will be appreciated by the skilled person that not all of the functionality present in the embodiments described above need necessarily be present in other embodiments of the present invention. For example, other embodiments of the invention do not perform landing detection (i.e., they do not determine that the aircraft has landed on the basis of a measured distance falling below a predetermined distance threshold). Similarly, other embodiments may perform landing detection but do not automatically determine the predetermined distance threshold. Instead, in such embodiments, it may be that the predetermined distance threshold is pre-programmed into the signal processing electronics 107 (for example, stored in the memory 239).

As previously discussed, the signal processing electronics 107 described above comprises a processor 237 and an associated memory 239. The processor 237 and the associated memory 239 may be configured to perform one or more of the above-described functions of the ground detection system. Each device, module, component, machine or function as described in relation to any of the examples described herein (for example, clamp circuit 229 or Schmitt trigger 233) may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also include computer programs, particularly computer programs on or in a carrier, adapted for putting the above-described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of the ground detection system may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

The one or more processors may comprise data storage. The data storage may comprise one or both of volatile and non-volatile memory. The data storage may comprise one or more of random access memory (RAM), read-only memory (ROM), a magnetic or optical disk and disk drive, or a solid-state drive (SSD). It will be appreciated by the skilled person that many other types of memory, in addition to the examples provided, may also be used. It will be appreciated by a person skilled in the art that the one or more processors may each comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, while of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A ground detection system for an aircraft, the system comprising:
an aircraft landing gear;
an electrode mounted to the aircraft landing gear and arranged such that, as the aircraft landing gear approaches the ground, the electrode and the ground together form a variable capacitor having a capacitance that depends on a distance of the electrode from the ground; and
signal processing electronics configured to measure the capacitance and, based on a measured capacitance, determine a distance of the aircraft from the ground.

2. The system according to claim 1, wherein:
the signal processing electronics comprise an oscillator having a resonant tank circuit; and
the variable capacitor formed by the electrode and the ground comprises part of the resonant tank circuit, such that variation in the capacitance of the variable capacitor causes a variation in an operating frequency of the oscillator.

3. The system according to claim 2, wherein the signal processing electronics are configured to measure the capacitance by measuring the operating frequency of the oscillator.

4. The system according to claim 1, wherein:
the aircraft landing gear comprises a wheel; and
the wheel forms the electrode.

5. The system according to claim 1, wherein the signal processing electronics are configured to detect, based on the determined distance falling below a predetermined distance threshold, that the aircraft has landed.

6. The system according to claim 5, wherein the signal processing electronics are configured to determine the predetermined distance threshold by, when the aircraft is in a weight on wheels configuration, measuring the capacitance of the variable capacitor.

7. The system according to claim 5, wherein the signal processing electronics are configured to, in response to detecting that the aircraft has landed, cause an activation of one or more aircraft deceleration systems.

8. The system according to claim 1, wherein the signal processing electronics are configured to repeat the measuring of the capacitance and the determining of a distance of the aircraft from the ground over a period of time to collect a series of measurements of the distance of the aircraft from the ground.

9. The system according to claim 8, wherein the signal processing electronics are configured to, based on the series of measurements, determine a sink rate of the aircraft.

10. The system according to claim 9, wherein the signal processing electronics are configured to detect that the aircraft has made a heavy landing by detecting that the determined sink rate exceeds a predetermined sink rate threshold.

11. The system according to claim 1, wherein the signal processing electronics are configured to measure the capacitance and determine the distance of the aircraft from the ground while the aircraft is in flight.

12. An aircraft comprising a ground detection system according to claim 1.

13. A method of ground detection for an aircraft, the method comprising:
providing, on an aircraft landing gear, an electrode configured such that, as the aircraft landing gear approaches the ground, the electrode and the ground together form a variable capacitor having a capacitance that depends on a distance of the electrode from the ground;
measuring the capacitance of the variable capacitor; and
determining, based on the measured capacitance, a distance of the aircraft from the ground.

14. A non-transitory computer readable medium storing a computer program comprising instructions which, when the program is executed by a computer, cause the computer to carry out a method of ground detection for an aircraft, the method comprising:
measuring a capacitance of a variable capacitor formed by an electrode mounted on a landing gear of the aircraft and the ground, wherein a capacitance of the variable capacitor depends on a distance of the electrode from the ground; and
determining, based on the measured capacitance, a distance of the aircraft from the ground.
